(19) United States
(12) Patent Application Publication
(10) Pub. No.: US 2024/0062147 A1
(43) Pub. Date: Feb. 22, 2024

(54) INFORMATION PROCESSING DEVICE, INFORMATION PROCESSING METHOD, INFORMATION PROCESSING SYSTEM, AND NON-TRANSITORY COMPUTER READABLE MEDIUM

(71) Applicant: Kabushiki Kaisha Toshiba, Tokyo (JP)

(72) Inventors: Tomoya UKAWA, Kawasaki Kanagawa (JP); Shizu SAKAKIBARA, Kawasaki Kanagawa (JP); Hideyuki AISU, Kawasaki Kanagawa (JP)

(73) Assignee: Kabushiki Kaisha Toshiba, Tokyo (JP)

(21) Appl. No.: 18/182,276

(22) Filed: Mar. 10, 2023

(30) Foreign Application Priority Data
Aug. 19, 2022 (JP) 2022-131347

(51) Int. Cl. G06Q 10/0835; G06Q 10/0832

(52) U.S. Cl. CPC G06Q 10/08355; G06Q 10/0832

(57) ABSTRACT

According to one embodiment, an information processing device includes processing circuitry configured to create, based on information on demand for a medium at one or more demand points and information on production of the medium which is able to be manufactured at a manufacturing point capable of manufacturing the medium, a first schedule for delivering a first container containing the medium among a plurality of points including the manufacturing point and the demand point. The processing circuitry is configured to create the first schedule based on a constraint that a difference between pressure inside the first container that is delivered to the demand point and pressure inside a second container at the demand point satisfies a condition necessary for transferring the medium from the first container to the second container.

### CROSS REFERENCE TO RELATED APPLICATIONS

This application is based upon and claims the benefit of priority from the prior Japanese Patent Application No. 2022-131347, filed on Aug. 19, 2022, the entire contents of which are incorporated herein by reference.

### FIELD

The present embodiments relate to an information processing device, an information processing method, an information processing system, and a non-transitory computer readable medium.

### BACKGROUND

Hydrogen energy is garnering attention toward decarbonization. In hydrogen utilization toward decarbonization, not only the use of hydrogen but an entire hydrogen supply chain including production, transportation, and storage of hydrogen must be brought into focus. In hydrogen transportation in a hydrogen supply chain, there are methods of placing hydrogen manufactured at a hydrogen manufacturing point into hydrogen containers and transporting the hydrogen containers to each demand point. In doing so, each hydrogen container, each transporter, and the like must be managed efficiently.

Management methods include a method of creating a schedule for minimizing a total transportation distance during hydrogen transportation. However, this method is an optimization method premised on all demand points being able to use up all of the hydrogen in the hydrogen containers. However, as a constraint unique to hydrogen, when using hydrogen at a demand point, the hydrogen is used by transferring the hydrogen from a hydrogen container to a supply destination container (for example, a fuel cell vehicle (FCV), a fuel cell (FC), or a FC forklift) at the demand point. Internal differential pressure between the delivered hydrogen container and the supply destination container at the demand point is utilized when transferring hydrogen. Therefore, there are cases where hydrogen cannot be supplied to the supply destination container at the demand point unless the hydrogen container holds a certain amount of hydrogen or more. Since there may be cases where hydrogen cannot actually be used at a demand point when a schedule is created without taking the constraint into consideration, as a result, accuracy of the created schedule declines.

### BRIEF DESCRIPTION OF THE DRAWINGS

FIG. 1 is a diagram showing an example of hydrogen delivery among a plurality of points including a hydrogen manufacturing point and a demand point according to a first embodiment;

FIG. 2 is a diagram showing an example of transferring hydrogen from a hydrogen container to a supply destination container;

FIGS. 3A and 3B show a case where hydrogen can be transferred and a case where hydrogen cannot be transferred in accordance with a difference in container internal pressure;

FIG. 4 is a diagram showing an example of refilling hydrogen from a tank of a tank truck to a storage tank;

FIG. 5 is a block diagram of an example of a schedule creation device according to the first embodiment;

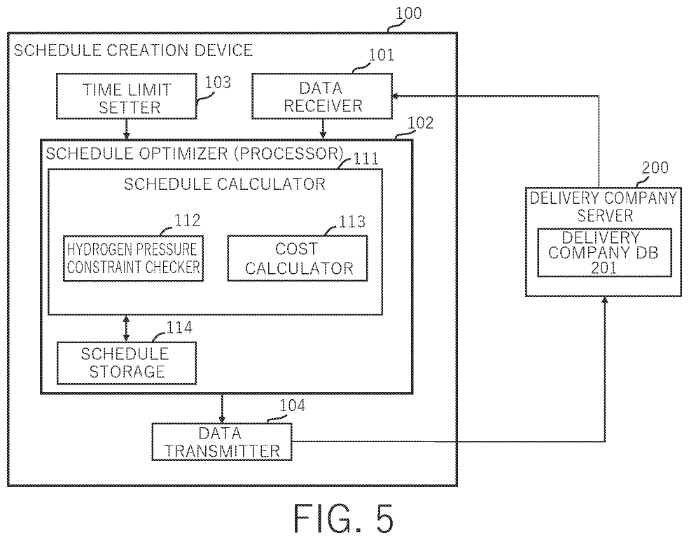

FIG. 6 is a diagram showing an example of a planned period and the number of usable hydrogen containers in delivery company data according to the first embodiment;

FIG. 7 is a diagram showing an example of inter-point distance data in delivery company data according to the first embodiment;

FIG. 8 is a diagram showing an example of detailed point data in delivery company data according to the first embodiment;

FIG. 9 is a diagram showing an example of variables of which values are known;

FIG. 10 is a diagram showing an example of variables to be optimized (variables of which values are unknown);

FIG. 11 is a diagram showing an output example of a hydrogen delivery schedule according to the first embodiment;

FIG. 12 is a flow chart of an example of optimization of a hydrogen delivery schedule according to the first embodiment;

FIG. 13 is a block diagram of an example of a schedule creation device according to a second embodiment;

FIG. 14 is a flow chart of an example of processing of a delivery area divider according to the second embodiment;

FIG. 15 is a diagram showing an example of hydrogen delivery among a plurality of points including a hydrogen manufacturing point and a demand point according to the second embodiment;

FIG. 16 is a diagram showing an output example of a hydrogen delivery schedule according to the second embodiment; and

FIG. 17 is a hardware block diagram of a schedule creation device according to an embodiment of the present invention.

### DETAILED DESCRIPTION

According to one embodiment, an information processing device includes processing circuitry configured to create, based on information on demand for a medium at one or more demand points and information on production of the medium which is able to be manufactured at a manufacturing point capable of manufacturing the medium, a first schedule for delivering a first container containing the medium among a plurality of points including the manufacturing point and the demand point. The processing circuitry is configured to create the first schedule based on a constraint that a difference between pressure inside the first container that is delivered to the demand point and pressure inside a second container at the demand point satisfies a condition necessary for transferring the medium from the first container to the second container.

Hereinafter, embodiments of the present invention will be described with reference to the drawings.

### First Embodiment

First, an outline of the present embodiment will be described.

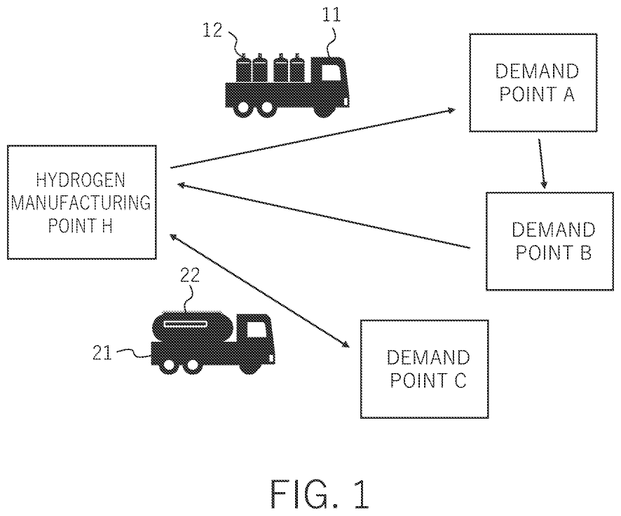

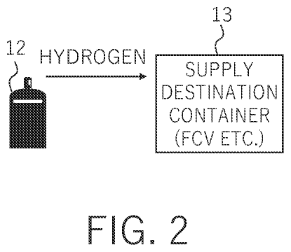

FIG. 1 shows an example of hydrogen delivery among points according to the present embodiment. FIGS. 2 to 4 are supplementary explanatory diagrams of FIG. 1. For example, FIG. 1 shows an example of hydrogen delivery on a given day. At a hydrogen manufacturing point (also referred to as a hydrogen supply point) H, a hydrogen container 12 (first container) refilled with hydrogen being a medium is loaded onto a truck 11 and the truck 11 departs the hydrogen manufacturing point H. The truck 11 transports hydrogen containers in order to a demand point A and a demand point B and then returns to the hydrogen manufacturing point H.

The hydrogen containers delivered to the demand points A and B are used to supply or, in other words, transfer hydrogen to a supply destination container (second container). Examples of the supply destination container (second container) include an FCV (fuel cell vehicle), an FC, an FC scooter, an FC forklift, and a hydrogen jet airplane. In some cases, transferring the hydrogen in a hydrogen container to the supply destination container will be referred to as using the hydrogen inside the hydrogen container.

FIG. 2 shows an example of transferring hydrogen from the hydrogen container 12 to a supply destination container 13. The transfer of hydrogen from the hydrogen container 12 to the supply destination container 13 is performed using a difference in container internal pressure. The transfer of hydrogen is performed when the difference in container internal pressure satisfies a condition (an intra-container differential pressure condition) necessary for transferring hydrogen. Specifically, when the container internal pressure of the hydrogen container 12 is higher than the container internal pressure of the supply destination container 13, hydrogen in the hydrogen container 12 with higher pressure is transferred to the supply destination container 13 with lower pressure. When an amount of hydrogen in the hydrogen container 12 decreases, the pressure in the hydrogen container 12 drops. When the pressure inside the hydrogen container 12 equals or drops below the pressure inside the supply destination container 13, hydrogen can no longer be transferred to the supply destination container 13.

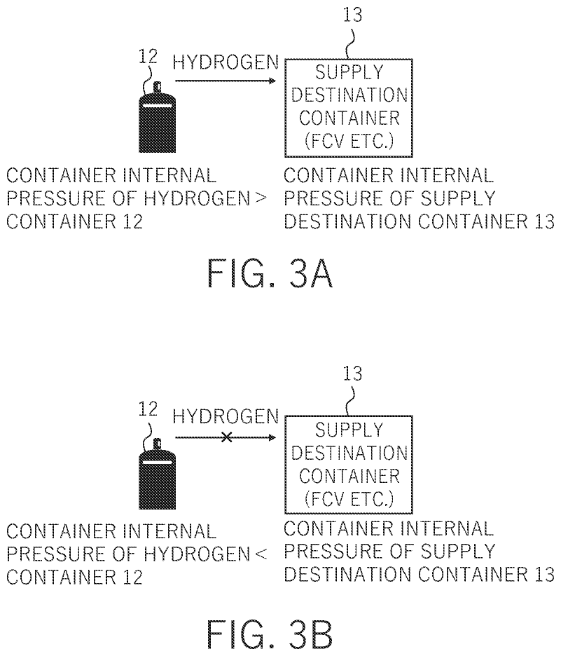

FIG. 3A schematically shows a case where the difference in container internal pressure satisfies a condition (the intra-container differential pressure condition) necessary for transferring hydrogen and hydrogen can be transferred from the hydrogen container 12 to the supply destination container 13. FIG. 3B schematically shows a case where the difference in container internal pressure does not satisfy the condition (the intra-container differential pressure condition) necessary for transferring hydrogen and hydrogen cannot be transferred from the hydrogen container 12 to the supply destination container 13.

In the example of hydrogen delivery shown in FIG. 1, a used hydrogen container can be collected at at least one of the demand point A and the demand point B. In addition, a hydrogen container collected at the demand point A can be carried to the demand point B. For example, hydrogen in the hydrogen container collected at the demand point A may be usable at the demand point B. Let us assume that pressure in the hydrogen container drops at the demand point A and hydrogen can no longer be transferred to a supply destination container and, therefore, the hydrogen container becomes used at the demand point A. On the other hand, pressure of the supply destination container (for example, an FC) is expected to be low at the demand point B and the container internal pressure of the hydrogen container having become used is expected to be higher than the container internal pressure of the supply destination container at the demand point A. In this case, the hydrogen container having become used at the demand point A can be reused at the demand point B. Note that an upper limit of pressure inside the supply destination container is determined in advance in accordance with intended use or the like

In the example of the hydrogen delivery shown in FIG. 1, a tank truck 21 refills a tank 22 with hydrogen at the hydrogen manufacturing point H, the tank truck 21 departs the hydrogen manufacturing point H, and hydrogen is supplied (refilled) from the tank 22 to a storage tank installed at a demand point C.

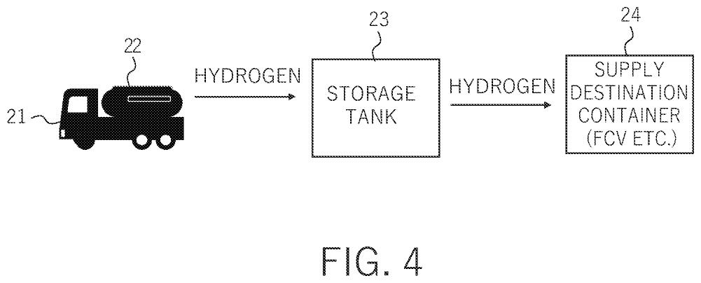

FIG. 4 shows an example of refilling hydrogen from the tank 22 of the tank truck 21 to a storage tank 23. The hydrogen supplied to the storage tank 23 can be used in any way. For example, the hydrogen refilled to the storage tank 23 can be transferred to a supply destination container 24 (second container) (the hydrogen inside the storage tank 23 can be used). The hydrogen can also be supplied from the storage tank 23 to an empty hydrogen container.

After refilling hydrogen at the demand point C, the tank truck 21 returns to the hydrogen manufacturing point H. There can be cases where the tank truck 21 visits at least one of the demand point A and the demand point B after the demand point C instead of immediately returning to the hydrogen manufacturing point H and hydrogen is supplied to a storage tank at the visited demand point A or demand point B from the tank truck 21. There can be demand points where a storage tank is not provided. For example, there can be a case where the demand point A has a storage tank but the demand point B does not have a storage tank.

In order to carry out the hydrogen delivery such as that shown in FIG. 1 in an efficient manner, a schedule (a hydrogen delivery schedule or a first schedule) for delivering hydrogen to each demand point must be created based on a daily demand for hydrogen at each demand point and a daily production of hydrogen at the hydrogen manufacturing point. For example, the hydrogen delivery schedule (first schedule) determines how many hydrogen containers are to be supplied and how much hydrogen is to be supplied to storage tanks at which demand point and at what timing, how many hydrogen containers are to be collected at which demand point and at what timing, and the like. In addition, a schedule (a hydrogen use schedule or a second schedule) for using hydrogen at each demand point such as how much hydrogen in a delivered hydrogen container is to be used at what timing, how much hydrogen in a storage tank is to be used at what timing, or the like is created along with the hydrogen delivery schedule. In the present embodiment, the hydrogen delivery schedule for optimizing hydrogen delivery as described above is created along with the hydrogen use schedule. Hereinafter, when simply referred to as a “schedule”, the schedule is to include both the hydrogen delivery schedule and the hydrogen use schedule.

While hydrogen is handled as a medium that is an object of creating a schedule in the present embodiment, the medium that is an object is not limited to hydrogen and the medium may be any gas, liquid, or solid as long as the medium can be delivered to and used at a demand point. For example, oxygen may be used as a gas other than hydrogen and, as a medium other than a gas, a liquid such as liquid hydrogen or liquid nitrogen may be used or a solid such as solid hydrogen or solid oxygen may be used.

FIG. 4 is a block diagram of an example of a schedule creation device 100 as an information processing device according to the present embodiment. The schedule creation device 100 is connected, via a communication network, to a delivery company server 200 provided on a side of a hydrogen delivery company.

The delivery company server 200 is provided with a delivery company DB 201. The delivery company DB 201 stores data (delivery company data) necessary for creating a schedule. The delivery company server 200 transmits creation instruction data of a hydrogen delivery schedule to the schedule creation device 100 together with delivery company data. The transmission may be performed based on an instruction by a user in the delivery company or performed by a timer at a time of day set in advance. In addition to the delivery company DB 201, the delivery company server 200 may be provided with an input device to be used by the user to input information or instructions, a displayer for outputting information to the user, and the like. Furthermore, the delivery company server 200 is provided with a communicator for performing wireless or wired communication with the schedule creation device 100.

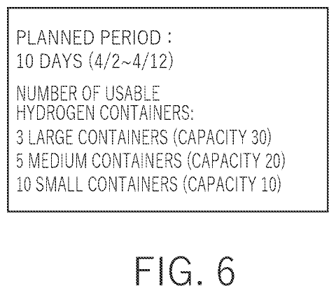

FIGS. 6 to 8 show examples of delivery company data stored in the delivery company DB 201.

FIG. 6 shows a data example of a planned period and the number of usable hydrogen containers. The planned period data indicates information on a planned period to be a creation object of a schedule. In the present example, the planned period is 10 days from April 2nd to 12th. Values of the period may be modifiable as a parameter by user input.

The number of usable hydrogen containers indicates information on the number of hydrogen containers to be used in a plan. All of the hydrogen containers can be loaded onto a truck at a time. In the present example, a total of 18 hydrogen containers including three large hydrogen containers (capacity 30), five medium hydrogen containers (capacity 20), and ten small hydrogen containers (capacity 10) can be used. However, it is not necessarily essential to use all of the hydrogen containers. Using as few hydrogen containers as possible may be adopted as a constraint condition of the plan. The number of usable hydrogen containers is to remain the same during the planned period. In other words, in the example shown in FIG. 6, a delivery schedule is created in which a maximum of 18 hydrogen containers are to be recycled.

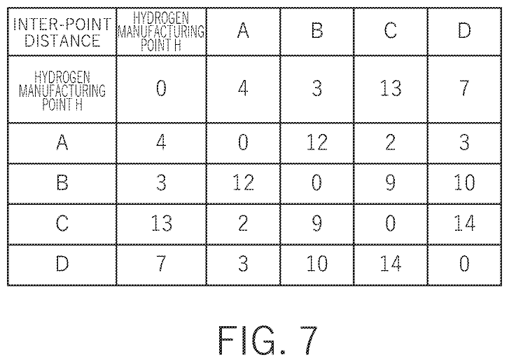

FIG. 7 shows a data example of an inter-point distance. Distance data is indicated for each set of any two points among a group of points including a hydrogen manufacturing point and a plurality of demand points. For example, the distance between the demand point A and the demand point B is 12. The distance between the hydrogen manufacturing point H and the demand point C is 13. Note that a distance may be normalized according to an objective function of optimization to be described later.

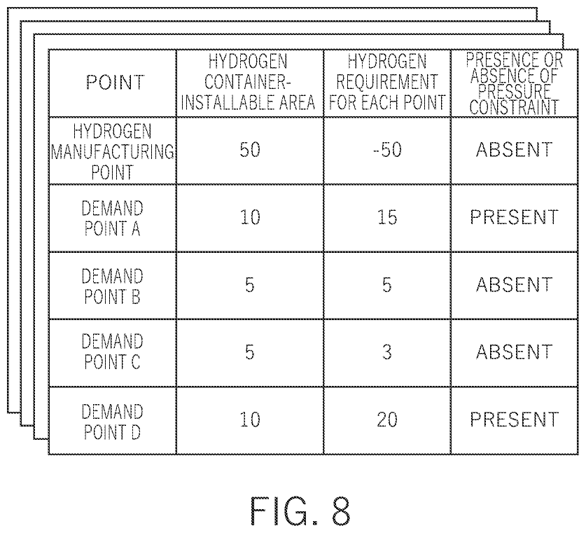

FIG. 8 shows, as detailed information of a plurality of points, a data example of a hydrogen container-installable area, a hydrogen requirement, and a presence or absence of a constraint of the intra-container differential pressure condition (an intra-container differential pressure constraint) of each point. FIG. 8 shows a specific example of one day's worth of data (for example, data for April 2nd). Data is stored in a similar format with respect to a plurality of other days including the other nine days of the planned period (in the present example, 10 days).

The hydrogen container-installable area represents a size of a region where a hydrogen container can be installed. Let us suppose that an area occupied by the small hydrogen container is 1, an area occupied by the medium hydrogen container is 2, and an area occupied by the large hydrogen container is 3. At the demand point A of which the hydrogen container-installable area is 10, a maximum of 10 hydrogen containers can be placed if only using the small hydrogen containers. In a similar manner, a maximum of five hydrogen containers can be placed if only using the medium hydrogen containers and a maximum of three hydrogen containers can be placed if only using the large hydrogen containers. In addition, hydrogen containers with a plurality of capacities can be placed such as four small hydrogen containers and two large hydrogen containers. The size of each hydrogen container and the area occupied by each size are associated with each other in advance.

The hydrogen container-installable area can differ from day to day. For example, at the hydrogen manufacturing point H, using a part of the installation region in order to carry out some work on a given day may prevent hydrogen containers from being placed in the part of the installation region. In such a case, since the part of the installation region cannot be counted as a region for installation, the hydrogen container-installable area decreases. When the hydrogen container-installable area does not differ from day to day in this manner, the hydrogen container-installable area may be set to a same value for all days.

The hydrogen requirement represents a production (supply) of hydrogen in the case of a hydrogen manufacturing point H1 and represents an amount of use or an amount of consumption of hydrogen in the case of a demand point. Production is represented by a negative value but an amount of use is represented by a positive value.

The presence or absence of a pressure constraint indicates whether or not there is a constraint on container internal pressure in accordance with an intended use of hydrogen at a demand point. For example, when transferring hydrogen from a hydrogen container to an FC (fuel cell) as a supply destination container at a demand point, since the container internal pressure of the FC is low and the hydrogen container has higher container internal pressure, there is no constraint on container internal pressure. On the other hand, when transferring hydrogen from a hydrogen container to an FCV (fuel cell vehicle) as a supply destination container, pressure rises as the FCV approaches full tank and the container internal pressure of the FCV can exceed the container internal pressure of the hydrogen container. In this case, hydrogen can no longer be transferred from the hydrogen container to the FCV. Therefore, when transferring hydrogen from the hydrogen container to the FCV, there is a constraint on container internal pressure.

The schedule creation device 100 shown in FIG. 4 includes a data receiver 101, a schedule optimizer 102 (processor), a time limit setter 103, and a data transmitter 104. The schedule optimizer 102 includes a schedule calculator 111 and a schedule storage 114. The schedule calculator 111 includes a hydrogen pressure constraint checker 112 and a cost calculator 113. The schedule optimizer 102 can be configured by processing circuitry.

The data receiver 101 receives data (delivery company data) of the delivery company DB 201 from the delivery company server 200.

The time limit setter 103 sets a time limit of schedule creation performed by the schedule optimizer 102.

The schedule optimizer 102 (processor) creates a schedule (a hydrogen delivery schedule and a hydrogen use schedule) by searching for and assessing a schedule within the time limit based on the delivery company data. For example, based on information on demand for hydrogen at one or more demand points and information on production of hydrogen which can be manufactured at a hydrogen manufacturing point capable of manufacturing hydrogen, the schedule optimizer 102 (processor) creates a hydrogen delivery schedule (first schedule) for delivering hydrogen containers containing hydrogen among a plurality of points (the hydrogen manufacturing point and the demand points). The schedule optimizer 102 further creates a hydrogen use schedule (second schedule) for using the hydrogen in the hydrogen containers at each demand point.

More specifically, the schedule calculator 111 generates an objective function and a constraint condition which represent a total cost of a schedule and, by optimizing the objective function based on the constraint condition, creates an optimal or suboptimal schedule. For example, the constraint condition includes a constraint that, upon use of hydrogen inside a hydrogen container delivered to a demand point, a difference between pressure inside the hydrogen container delivered to the demand point and pressure inside a supply destination container at the demand point satisfies a condition (the intra-container differential pressure condition) necessary for transferring a medium from the hydrogen container to the supply destination container.

The cost calculator 113 included in the schedule calculator 111 has a function of calculating a value of the objective function (which corresponds to a cost or an assessed value). The hydrogen pressure constraint checker 112 included in the schedule calculator 111 has a function of checking, during optimization, whether the schedule to be created satisfies the intra-container differential pressure condition among the constraint condition. Every time the schedule calculator 111 creates a schedule based on a search, the schedule calculator 111 stores the created schedule (a hydrogen delivery schedule and a hydrogen use schedule) together with an assessed value in the schedule storage 114.

The data transmitter 104 specifies a schedule with a highest assessment among schedules stored in the schedule storage 114 as an optimal or suboptimal schedule and transmits data of the specified schedule to the delivery company server 200. The delivery company server 200 stores the received data of the hydrogen delivery schedule in the delivery company DB 201. The stored data may be displayed on a displayer by an operation performed by an operator (user) in the delivery company so as to be visible from the user.

Hereinafter, a mathematical model used in optimization by the schedule optimizer 102 will be described.

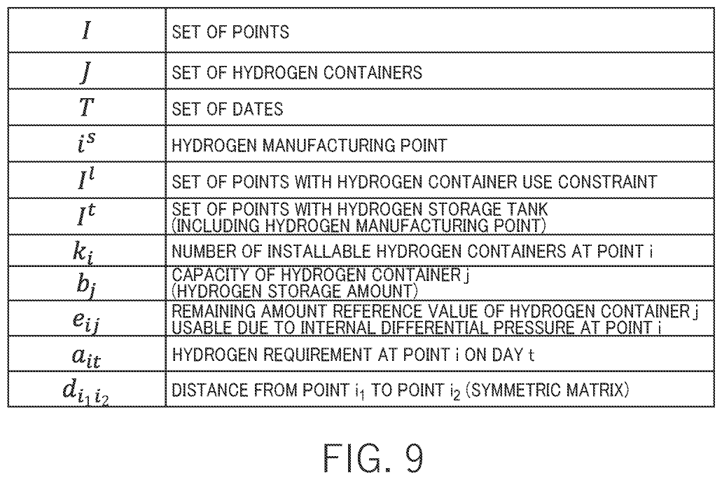

FIG. 9 shows an example of variables of which values are known. The values of the variables shown in FIG. 9 are determined from delivery company data or the like.

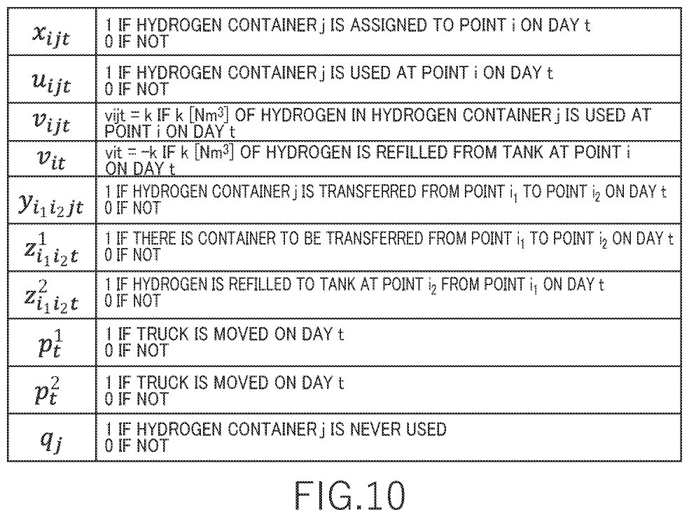

FIG. 10 shows an example of variables of which values are unknown. The values of the variables shown in FIG. 10 are unknown and are to be determined by optimization performed by the schedule optimizer 102. Searching for the values of the variables corresponds to searching for a schedule.

Hereinafter, an example of an objective function (expression 0) and constraint expressions (expressions 1 to 19) of the mathematical model will be described.

$$\begin{matrix}[ Expression 1 ] & \\ \begin{matrix}min & {\sum }_{{i}_{1} ∈ I} {\sum }_{{i}_{2} ∈ I} {\sum }_{j ∈ J} {\sum }_{t ∈ T} {d}_{{i}_{1} {i}_{2}} {z}_{{i}_{1} {i}_{2} t}^{1} + {d}_{{i}_{1} {i}_{2}} {z}_{{i}_{1} {i}_{2} t}^{2} + {w}_{1} {p}_{t}^{1} + {w}_{2} {p}_{t}^{2} + {w}_{3} {q}_{j}\end{matrix} & ( 0 )\end{matrix}$$

$$\begin{matrix}s . t . & {\sum }_{i ∈ I} {x}_{ijt} = 1 , & i ∈ I , j ∈ J , t ∈ T .\end{matrix} \qquad ( 1 )$$

$$\begin{matrix}{\sum }_{j ∈ J} {x}_{ijt} \leq {k}_{i} , & i ∈ I , j ∈ J , t ∈ T .\end{matrix} \qquad ( 2 )$$

$$\begin{matrix}{\sum }_{j ∈ J} {v}_{ijt} = {a}_{it} , & i ∈ I , t ∈ T .\end{matrix} \qquad ( 3 )$$

$$\begin{matrix}{\sum }_{{i}_{1} ∈ I} {\sum }_{{t}_{1} = 0}^{{t}_{2}} {v}_{{i}_{1} {jt}_{1}} \leq {b}_{j} - {e}_{{i}_{2} j} {u}_{{i}_{2} {jt}_{2}} & {i}_{2} ∈ {I}^{l} , j ∈ J , {t}_{2} ∈ T .\end{matrix} \qquad ( 4 )$$

$$\begin{matrix}{\sum }_{i ∈ I} {\sum }_{t ∈ T} \frac{{u}_{ijt}}{M} \leq 1 - {q}_{j} , & j ∈ J .\end{matrix} \qquad ( 5 )$$

$$\begin{matrix}{\sum }_{j ∈ J} {y}_{{i}_{1} {i}_{2} jt} \leq M {z}_{{i}_{1} {i}_{2} t}^{1} , & {i}_{1} , {i}_{2} ∈ I , t ∈ T .\end{matrix} \qquad ( 6 )$$

$$\begin{matrix}{\sum }_{{i}_{1} ∈ I} {\sum }_{{i}_{2} ∈ I} {z}_{{i}_{1} {i}_{2} t}^{1} \leq M {p}_{t}^{1} , & t ∈ T .\end{matrix} \qquad ( 7 )$$

$$\begin{matrix}{\sum }_{{i}_{1} ∈ {I}^{t}} {\sum }_{{i}_{2} ∈ {I}^{t}} {z}_{{i}_{1} {i}_{2} t}^{2} \leq M {p}_{t}^{2} , & t ∈ T .\end{matrix} \qquad ( 8 )$$

$$\begin{matrix}{\sum }_{j ∈ J} {v}_{{i}^{s} jt} + {\sum }_{{i}_{2} ∈ {I}^{t}} {v}_{{i}_{2} t} = {a}_{{i}^{s} t} , & t ∈ T .\end{matrix} \qquad ( 9 )$$

$$\begin{matrix}{\sum }_{{t}_{1} = 0}^{t} {v}_{{it}_{1}} + {\sum }_{{t}_{1} = 0}^{t} {a}_{{it}_{1}} - {\sum }_{{t}_{1} = 0}^{t} {\sum }_{j ∈ J} {v}_{{ijt}_{1}} \leq 0 , & i ∈ {I}^{t} , t ∈ T .\end{matrix} \qquad ( 10 )$$

$$\begin{matrix}0 \leq {\sum }_{i ∈ I} {\sum }_{{t}_{1} = 0}^{{t}_{2}} {v}_{{ijt}_{1}} \leq {b}_{j} , & j ∈ J , {t}_{2} ∈ T .\end{matrix} \qquad ( 11 )$$

$$\begin{matrix}- {Mu}_{ijt} \leq {v}_{ijt} \leq M {u}_{ijt} , & i ∈ I , j ∈ J , t ∈ T .\end{matrix} \qquad ( 12 )$$

$$\begin{matrix}{x}_{{i}^{s} j 0} = 1 , & j ∈ J .\end{matrix} \qquad ( 13 )$$

$$\begin{matrix}{u}_{ijt} \leq {x}_{ijt} , & i ∈ I , j ∈ J , t ∈ T .\end{matrix} \qquad ( 14 )$$

$$\begin{matrix}{v}_{ijt} \geq 0 , & i ∈ I ∖ {i}^{s} , j ∈ J , t ∈ T .\end{matrix} \qquad ( 15 )$$

$$\begin{matrix}{v}_{ijt} \leq 0 , & i ∈ {i}^{s} , j ∈ J , t ∈ T .\end{matrix} \qquad ( 16 )$$

$$\begin{matrix}{i}_{{i}_{1} jt - 1} + {x}_{{i}_{2} jt} - 1 \leq {y}_{{i}_{1} {i}_{2} jt} , & \begin{matrix}i = {i}_{1} ⋃ {i}_{2} ∈ I \backslash {i}^{s} ( {i}_{1} \neq {i}_{2} ) , j ∈ J , t \\ ∈ T .\end{matrix}\end{matrix} \qquad ( 17 )$$

$$\begin{matrix}- {v}_{it} \leq M {z}_{{i}^{s} it}^{2} & i ∈ {I}^{t} ∖ {i}^{s} , , t ∈ T .\end{matrix} \qquad ( 18 )$$

The objective function (expression 0) includes a term (first cost term) of a distance cost (dᵢ_{₁}ᵢ_{₂}zᵢ_{₁}ᵢ_{₂}ₜ¹+dᵢ_{₁}ᵢ_{₃}zᵢ_{₁}ᵢ_{₂}ₜ²) in accordance with a total travel distance of a truck which transports hydrogen containers and a tank truck which directly transports hydrogen and a term (second cost term) of a transportation cost (w₁pₜ¹+w₂pₜ²−w₃qⱼ) of the truck and the tank truck. The transportation cost includes a driver cost and a fuel cost.

Furthermore, when there is a hydrogen container j not used even once during the planned period due to −w₃qⱼ, the cost is reduced accordingly. In other words, efficient transportation is performed using as few hydrogen containers as possible among usable hydrogen containers. Constants w₁, w₂, and w₃ are weight coefficients. In other words, the objective function is a function including a sum of a term based on a distance cost (the first cost term), a term based on a transportation cost (the second cost term), and a term of a number cost based on the number of hydrogen containers to be used (a third cost term). The number cost is defined so as to assume a value of 0 when all of the hydrogen containers are used and the larger the number of hydrogen containers used, the smaller the cost. Note that 0 is simply an example and another fixed value may be used.

Hereinafter, the constraint condition will be described in detail. The constraint condition includes a plurality of constraint expressions 1 to 19.

Constraint expression 1 assigns the hydrogen container j to any one point i on day t (any day). In other words, constraint expression 1 represents the fact that a same hydrogen container is not assigned (delivered to or placed at) a plurality of points on a same day.

Constraint expression 2 sets an upper limit value of the number of installable hydrogen containers at each point on day t to k, per point. A value of k at each point on each day is specified by the method described earlier from the hydrogen container-installable area in the delivery company data. Constraint expression 2 corresponds to a constraint related to an area of a region in which hydrogen containers are installable at each point.

Constraint expression 3 uses hydrogen in an amount corresponding to a hydrogen requirement at a point on day t from a hydrogen container delivered to the point. Constraint expression 3 is applied to demand points which are not equipped with storage tanks. “Use” corresponds to transferring (supplying) hydrogen from a hydrogen container to a supply destination container. The hydrogen requirement at each point on day t is included in the delivery company data.

Constraint expression 4 expresses a constraint on internal differential pressure of a hydrogen container. When a remaining amount of a hydrogen container falls to or below a reference value eᵢⱼ, the hydrogen container is no longer usable at a point with a constraint on internal differential pressure. In other words, when a hydrogen container is used at a given point with a constraint on internal differential pressure, a total amount of used hydrogen from the hydrogen container (including cases where the hydrogen container has been used at other points prior to the given point) must be equal to or smaller than a value obtained by subtracting the reference value eᵢⱼ described above from a capacity (initial storage amount) of the hydrogen container at a time point where the hydrogen container is used up at the given point.

Hydrogen containers are prepared in the number of usable hydrogen containers shown in FIG. 6 for each size. Each hydrogen container is defined by bⱼ (refer to FIG. 9). Which container size is to be denoted by b₁, b₂, b₃, or the like is determined in advance. In the present embodiment, when refilling a hydrogen container with hydrogen at a hydrogen manufacturing point, it is assumed that the hydrogen container is refilled (fully refilled) with hydrogen up to a capacity corresponding to the size of the hydrogen container. However, there may also be cases where a hydrogen container is not fully refilled but only refilled by hydrogen in a necessary amount (any amount).

Constraint expressions 5 to 8 represent constraints of variables included in the objective function.

Constraint expression 5 represents the fact that qⱼ=1 is satisfied when there is a hydrogen container j of which a use amount is 0 at any point (including a hydrogen manufacturing point) on any day. In other words, qⱼ=1 is satisfied when there is a hydrogen container which has never been refilled at the hydrogen manufacturing point. A hydrogen container that has never been used is also not delivered by the truck.

Constraint expression 6 represents the fact that zᵢ_{₁}ᵢ_{₂}ₜ¹=1 is satisfied when any hydrogen container j is transferred from a point i₁ to a point i₂ on day t.

Constraint expression 7 represents the fact that pₜ¹=1 is satisfied (the truck is moved) when the number of times zᵢ_{₁}ᵢ_{₂}ₜ¹ equals 1 on day t equals or exceeds 1. M denotes an adjustment coefficient.

Constraint expression 8 represents the fact that pₜ²=1 is satisfied (the tank truck is moved) when the number of times zᵢ_{₁}ᵢ_{₂}ₜ² equals 1 on day t equals or exceeds 1. M denotes an adjustment coefficient. zᵢ_{₁}ᵢ_{₂}ₜ² is satisfied when the tank truck is moved from the point i₁ to the point i₂ and a storage tank at the point i₂ is refilled with hydrogen.

Constraint expressions 9 to 16 represent constraints related to the use of a hydrogen container or a storage tank.

Constraint expression 9 means that, in order to use hydrogen manufactured at the hydrogen manufacturing point (=i^{s}) without waste, the hydrogen manufactured at the hydrogen manufacturing point i^{s} is used to refill a hydrogen container placed at the hydrogen manufacturing point or carried by a tank truck to a demand point with a storage tank and used to refill the storage tank.

More specifically, constraint expression 9 represents the fact that an amount of hydrogen manufactured at the hydrogen manufacturing point on day t equals a sum of an amount of hydrogen used to refill hydrogen containers at the hydrogen manufacturing point and an amount of hydrogen used to refill storage tanks at demand points from the tank truck.

Note that aᵢsₜ on a right side of constraint expression 9 has a negative value (since production of hydrogen (hydrogen requirement) at the hydrogen manufacturing point is represented by a negative value). In addition, vᵢ_{^{s}}ⱼₜ and vᵢ_{₂}ₜ on a left side are respectively also negative values (since refilling hydrogen to hydrogen containers at the hydrogen manufacturing point and refilling hydrogen to storage tanks at demand points from the tank truck are represented by negative values). Therefore, the left side and the right side of the constraint expression both have negative values and are equal to each other.

Constraint expression 10 represents a constraint on a capacity limit of a storage tank. Σₜ_{₁}₌₀^{t} denotes a hydrogen requirement at a demand point with a storage tank up to day t. This means that the hydrogen requirement is covered by the use of hydrogen from the hydrogen containers and the hydrogen stored in the storage tank. The constraint prevents hydrogen from being used beyond the amount of hydrogen inside the storage tank. Constraint expression 10 is applied to demand points which are equipped with storage tanks.

Constraint expression 11 represents a constraint on a capacity limit of a hydrogen container. Constraint expression 11 represents the fact that a remaining amount of a hydrogen container is within a range from 0 to a capacity bⱼ.

Constraint expression 12 represents the fact that, only with respect to a hydrogen container to be used, supply from the hydrogen container (use of hydrogen) and refilling to the hydrogen container (production of hydrogen) can be performed. With respect to vᵢⱼₜ, the use of hydrogen at a demand point takes a positive value and refilling of hydrogen to a hydrogen container at the hydrogen manufacturing point takes a negative value.

Constraint expression 13 represents the fact that all hydrogen containers are at the hydrogen manufacturing point on a first day (upon start of scheduling).

Constraint expression 14 represents the fact that a hydrogen container can only be used at a point to which the hydrogen container is assigned. In other words, a hydrogen container cannot be used at a point to which the hydrogen container is not assigned. “Using a hydrogen container” means using hydrogen stored in the hydrogen container (for example, by transferring the hydrogen to another supply destination container).

Constraint expression 15 represents the fact that, at a demand point other than the hydrogen manufacturing point, hydrogen in a hydrogen container can only be used on any day (day t). In other words, constraint expression 15 represents a ban on refilling hydrogen containers with hydrogen (vᵢⱼₜ taking a negative value) at a demand point.

Constraint expression 16 represents the fact that, at the hydrogen manufacturing point, hydrogen in any of the hydrogen containers is not used on any day (day t). In other words, constraint expression 16 represents a ban on using the hydrogen in the hydrogen containers at the hydrogen manufacturing point (the hydrogen containers can only be refilled with hydrogen).

Constraint expression 17 and constraint expression 18 represent constraints related to the transfer of hydrogen by the truck and the tank truck.

Constraint expression 17 represents the fact that, when a hydrogen container is transferred from a point i₁ to a point i₂, both and xᵢ_{₁}ⱼₜ₋₁ are 1 and a transfer counter yᵢ_{₁}ᵢ_{₂}ⱼₜ equals 1.

Constraint expression 18 represents the fact that zᵢ_{²}ᵢₜ²=1 is satisfied when transporting hydrogen with a tank truck from a hydrogen manufacturing point and refilling a hydrogen storage tank at a demand point with the hydrogen from the tank truck.

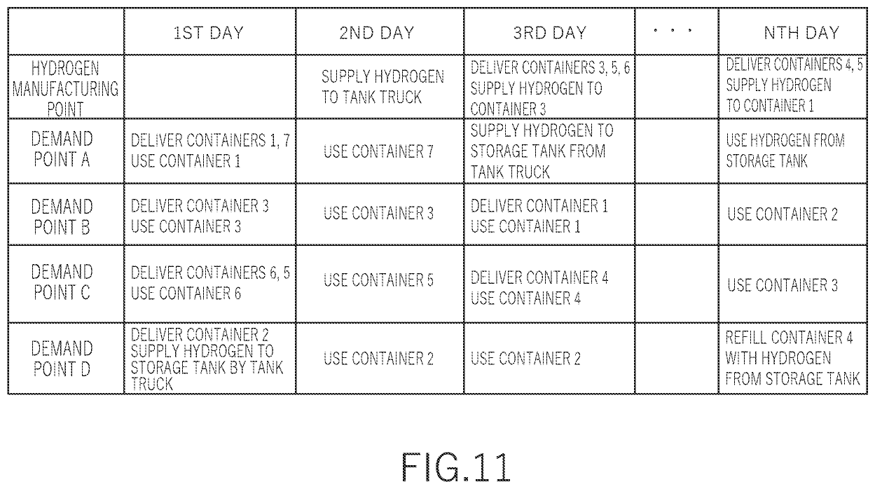

FIG. 11 shows an example of a schedule (a hydrogen delivery schedule and a hydrogen use schedule) having been optimized by the schedule optimizer 102. By optimizing the objective function described earlier based on the constraint condition, values of the variables shown in FIG. 10 are determined, and the schedule shown in FIG. 11 is determined based on the values of the variables.

For example, the hydrogen delivery schedule shown in FIG. 11 includes a schedule for delivering, on day 1, hydrogen containers 1 and 7 (first container) from the hydrogen manufacturing point to a demand point A. In addition, the hydrogen delivery schedule shown in FIG. 11 includes a schedule for delivering, on day 3, the hydrogen container 1 (first container) which no longer satisfies the intra-container differential pressure condition from the demand point A to a demand point B having a supply destination container (second container) which satisfies the intra-container differential pressure condition with respect to the hydrogen container 1. Furthermore, the hydrogen delivery schedule shown in FIG. 11 includes a schedule for delivering (collecting), on day 3, a hydrogen container 3 which no longer satisfies the intra-container differential pressure condition from the demand point B to the hydrogen manufacturing point. In addition, for example, the hydrogen use schedule shown in FIG. 11 includes using, on day 1 (first day), the hydrogen in the hydrogen container 1 delivered on day 1 according to the hydrogen delivery schedule. Furthermore, the hydrogen use schedule shown in FIG. 11 includes using, on day 2 (second day), the hydrogen in a hydrogen container 7 delivered on day 1 (first day) according to the hydrogen delivery schedule.

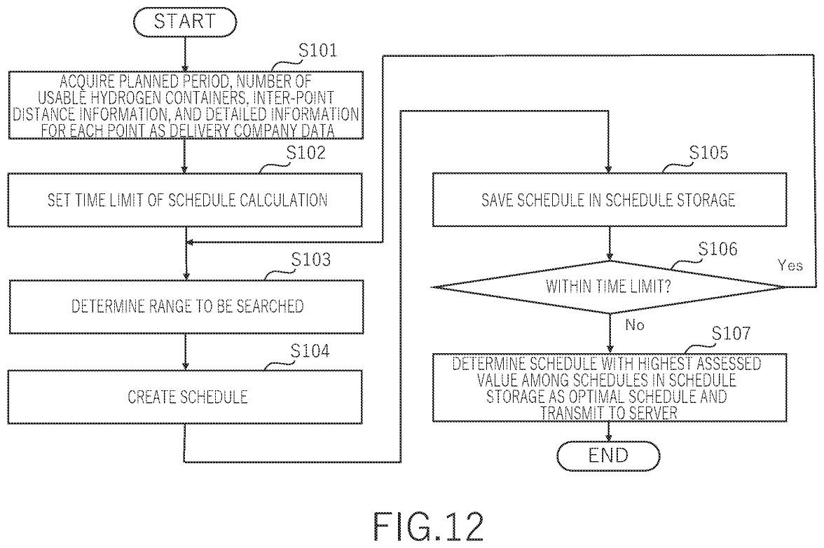

FIG. 12 shows a flow chart of an operation example of the schedule optimizer 102 according to the first embodiment. The data receiver 101 receives delivery company data from the delivery company server 200 (S101). The data receiver 101 sends the delivery company data to the schedule optimizer 102.

The time limit setter 103 sets a time limit of schedule creation (S102). A value determined in advance such as 10 minutes or 1 hour may be set as the time limit. Alternatively, a user in the delivery company may select a time limit from a plurality of options and transmit information indicating the selected time limit from the delivery company server 200.

The schedule optimizer 102 creates an optimal or suboptimal schedule (a hydrogen delivery schedule and a hydrogen use schedule) from the delivery company data obtained by the data receiver 101 within the time limit set by the time limit setter 103 (S103 to S106).

More specifically, the schedule optimizer 102 searches a search range of a schedule and creates a schedule which satisfies a hydrogen requirement for each point in the delivery company data (S103 and S104). For example, a search range may be specified by separating values of one or more variables.

The created schedule is sent to the schedule storage 114 together with a value (assessed value) of the objective function. The schedule storage 114 stores the schedule together with the assessed value (S105).

When the time limit has not passed (No in S106), a return is made to step S103 to modify the search range. When the time limit has passed (Yes in S106), the schedule search is ended.

The data transmitter 104 specifies a schedule with a highest assessed value among schedules stored in the schedule storage 114 as an optimal or suboptimal schedule (S107). The data transmitter 104 reads data of the specified schedule from the schedule storage 114 and transmits the data to the delivery company server 200 (same S107).

The data transmitted by the data transmitter 104 is not limited to a schedule. For example, information on at least one of the distance cost (first cost) and the transportation cost (second cost) described earlier may be transmitted. In addition, information related to the number cost (third cost) of hydrogen containers used in the schedule may be transmitted. For example, let us assume that the number of hydrogen containers usable for creating the schedule is N and that M-number of hydrogen containers are used in the schedule specified by optimization. In this case, a difference between N and M is the number of hydrogen containers not used in the first schedule, and information on the difference may be transmitted as information related to the third cost.

As described above, according to the present embodiment, even when there is a constraint that hydrogen cannot be supplied unless there is a certain amount of hydrogen or more in a hydrogen container such as when supplying hydrogen using internal differential pressure between the hydrogen container and a supply destination container, a schedule which takes such a constraint into consideration can be created. Since a premise of using up all of the hydrogen in a hydrogen container need not be postulated, a highly-accurate schedule can be created even when all of the hydrogen in a hydrogen container cannot be used up.

### Second Embodiment

Unlike the first embodiment, the present embodiment addresses medium- to large-scale delivery companies having a plurality of hydrogen manufacturing points. Such a delivery company conceivably divides a delivery area according to the demands of a demand point and the number of demand points that are in operation. A schedule optimizer according to the present embodiment not only determines a delivery schedule of hydrogen containers as in the first embodiment but, at the same time, also determines a delivery area for each hydrogen manufacturing point.

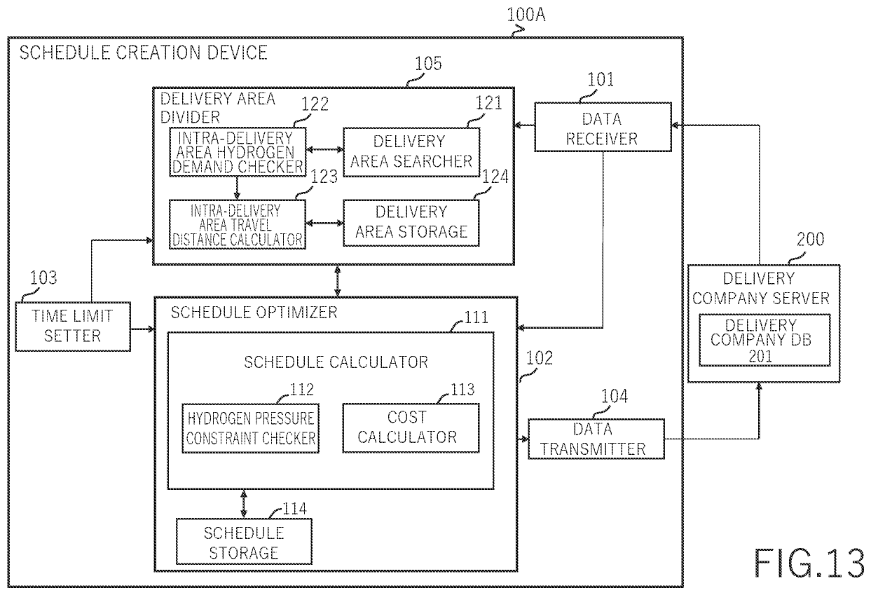

FIG. 13 is a block diagram of an example of a schedule creation device 100A according to the present embodiment. Compared to the configuration of the first embodiment, a delivery area divider 105 (processor) has been added to the schedule creation device in the present embodiment.

The delivery area divider 105 (processor) determines, based on position information and hydrogen production of the plurality of hydrogen manufacturing points and position information and hydrogen demands of a plurality of demand points, an area (delivery area) including demand points to be objects of delivery of hydrogen containers for each hydrogen manufacturing point. For example, the delivery area divider 105 (processor) determines a delivery area including one or more demand points for each hydrogen manufacturing point by combining one or more demand points for each hydrogen manufacturing point so that production equals or exceeds a sum of demands. In addition, a sum of distances between the hydrogen manufacturing point and the respective demand points in the delivery area is calculated and information indicating a variation of the sum among the hydrogen manufacturing points is calculated. The delivery area divider 105 (processor) determines the delivery area for each manufacturing point based on the variation information. For example, the delivery area for each manufacturing point is determined so as to minimize the variation.

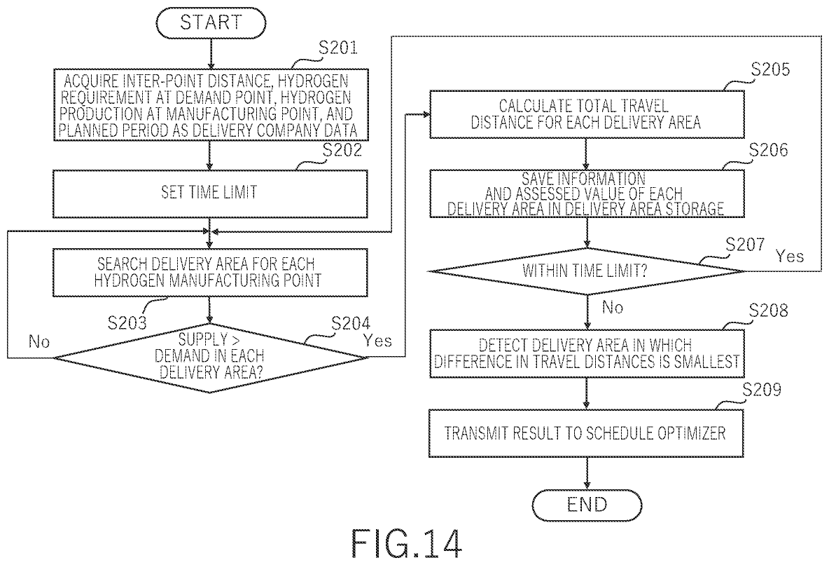

The delivery area divider 105 described above includes a delivery area searcher 121 which divides delivery areas, an intra-delivery area hydrogen demand checker 122 which checks whether or not hydrogen corresponding to a hydrogen demand can be supplied in a divided delivery area, an intra-delivery area travel distance calculator 123 which calculates a total travel distance in a delivery area, and a delivery area storage 124 which stores information on a calculated delivery area. Hereinafter, an operation of the delivery area divider 105 will be described in detail using the flow chart shown in FIG. 14.

FIG. 14 shows a flow chart of an operation example of the delivery area divider 105. The data receiver 101 acquires inter-point distances, hydrogen requirements at demand points, hydrogen requirements (hydrogen productions) at hydrogen manufacturing points, and a planned period which are data necessary for creating delivery areas as a part of the delivery company data from the server 200 (S201).

The time limit setter 103 sets a time limit (S202).

The delivery area searcher 121 searches a delivery area with respect to each hydrogen manufacturing point (S203). It is assumed that delivery areas do not overlap with each other.

The intra-delivery area hydrogen demand checker 122 checks, with respect to each delivery area determined by the delivery area searcher 121, whether a production (supply) of hydrogen in the planned period exceeds a sum of demands at the demand points (S204). When there is even one delivery area in which the production of hydrogen is smaller than the sum of demands (No), delivery areas are searched once again (S203).

When the production of hydrogen exceeds the sum of demands in all delivery areas (Yes), the intra-delivery area travel distance calculator 123 calculates a total travel distance for each delivery area and performs an assessment of the delivery areas (S205). The total travel distance refers to a sum of round-trip distances between the hydrogen manufacturing point and the demand points. For example, in the case of a hydrogen manufacturing point H and demand points A, B, and C, the total travel distance is a sum of round-trip distances between H and A, between H and B, and between H and C.

The smaller the difference in total travel distances between delivery areas, the smaller the variation in travel distances between delivery areas and, therefore, the higher the assessment. For example, a difference in total travel distances itself is adopted as an assessed value of variation, where the smaller the value, the higher the assessment. Alternatively, a dispersion or a standard deviation of the total travel distance may be adopted as an assessed value of variation. An assignment (a set of a hydrogen manufacturing point and one or more demand points in the delivery area of the hydrogen manufacturing point) and an assessed value of each delivery area are stored in the delivery area storage 124 (S206).

Subsequently, when still inside the time limit (Yes in S207), a return is made to processing by the delivery area searcher 121 once again to restart the search for a delivery area (S203). When the time limit has passed (No in S207), the search for a delivery area is ended. The delivery area divider 105 specifies an assignment of a delivery area with a highest assessment based on assessed values in the delivery area storage 124. The delivery area divider 105 transmits information indicating the specified assignment of the delivery area to the schedule optimizer 102 (S209).

Subsequently, in a state where delivery areas have been determined, the schedule optimizer 102 searches for a schedule (a hydrogen delivery schedule and a hydrogen use schedule) with demand points in the delivery areas as objects in a similar manner to the first embodiment. Accordingly, an optimized schedule is created for each delivery area.

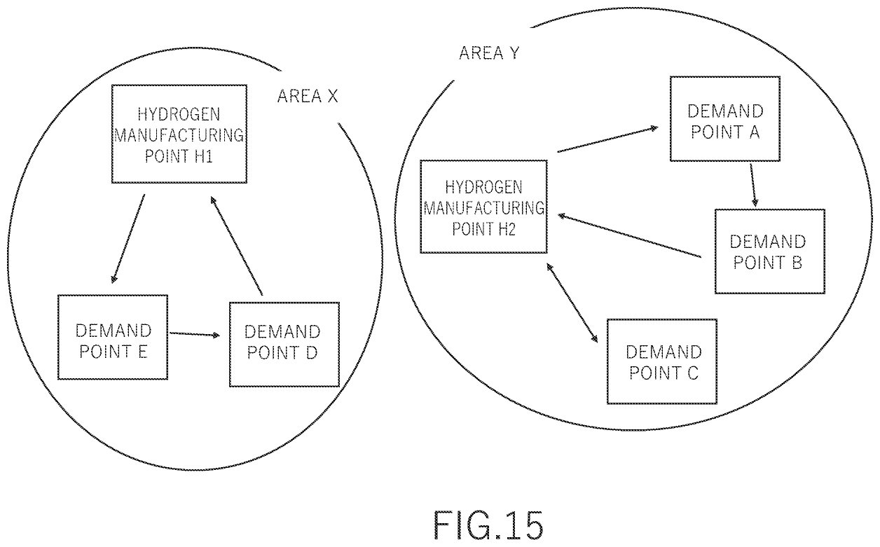

FIG. 15 shows an example of a delivery area determined for each hydrogen manufacturing point by the delivery area divider 105. Demand points A, B, and C are determined with respect to a hydrogen manufacturing point H1 and demand points D and E are determined with respect to a hydrogen manufacturing point H2. A delivery area including the hydrogen manufacturing point H1 and the demand points A, B, and C is an area X and a delivery area including the hydrogen manufacturing point H2 and the demand points D and E is an area Y. Note that paths indicated by arrows between points in the drawing represent paths along which a truck or a tank truck travels on a given day in the schedules respectively created for the area X and the area Y and do not mean that paths to be actually traveled are limited to these paths.

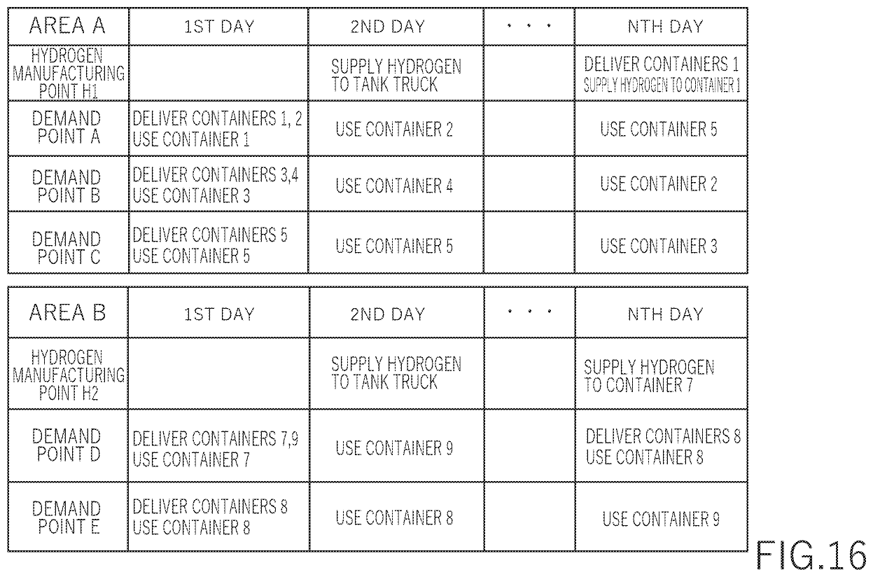

FIG. 16 shows an example of schedules respectively optimized for the area X and the area Y shown in FIG. 15 according to the present embodiment. Since the only difference from FIG. 11 is that there is a schedule for each area, a description will be omitted.

As described above, according to the present embodiment, a supply object area of hydrogen can be determined for each hydrogen manufacturing point and, at the same time, a hydrogen delivery schedule and a hydrogen use schedule in the area can be optimized.

### (Hardware Configuration)

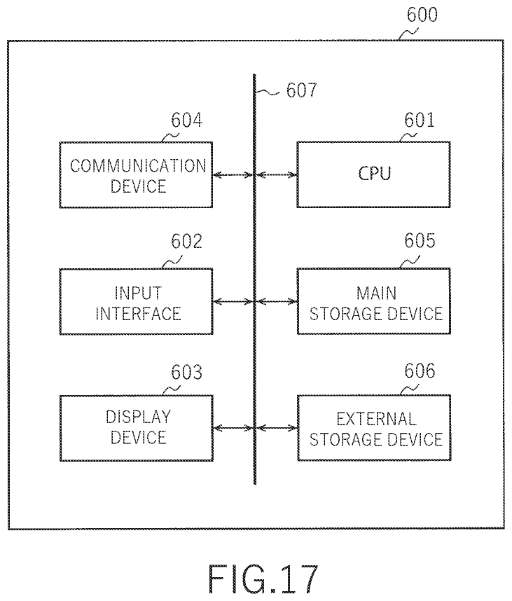

FIG. 17 illustrates a hardware configuration of the information processing device according to each embodiment. The information processing device is configured as a computer device 600. The computer device 600 includes a CPU 601, an input interface 602, a display device 603, a communication device 604, a main storage device 605, and an external storage device 606, and these components are mutually connected through a bus 607.

The CPU (central processing unit) 601 executes an information processing program as a computer program on the main storage device 605. The information processing program is a computer program configured to achieve each above-described functional component of the present device. The information processing program may be achieved by a combination of a plurality of computer programs and scripts instead of one computer program. Each functional component is achieved as the CPU 601 executes the information processing program.

The input interface 602 is a circuit for inputting, to the present device, an operation signal from an input device such as a keyboard, a mouse, or a touch panel. The input interface 602 corresponds to the input device 120.

The display device 603 displays data output from the present device. The display device 603 is, for example, a liquid crystal display (LCD), an organic electroluminescence display, a cathode-ray tube (CRT), or a plasma display (PDP) but is not limited thereto. Data output from the computer device 600 can be displayed on the display device 603.

The communication device 604 is a circuit for the present device to communicate with an external device in a wireless or wired manner. Data can be input from the external device through the communication device 604. The data input from the external device can be stored in the main storage device 605 or the external storage device 606.

The main storage device 605 stores, for example, the information processing program, data necessary for execution of the information processing program, and data generated through execution of the information processing program. The information processing program is loaded and executed on the main storage device 605. The main storage device 605 is, for example, a RAM, a DRAM, or an SRAM but is not limited thereto. Each storage or database in the information processing device in each embodiment may be implemented on the main storage device 605.

The external storage device 606 stores, for example, the information processing program, data necessary for execution of the information processing program, and data generated through execution of the information processing program. The information processing program and the data are read onto the main storage device 605 at execution of the information processing program. The external storage device 606 is, for example, a hard disk, an optical disk, a flash memory, or a magnetic tape but is not limited thereto. Each storage or database in the information processing device in each embodiment may be implemented on the external storage device 606.

The information processing program may be installed on the computer device 600 in advance or may be stored in a storage medium such as a CD-ROM. Moreover, the information processing program in each embodiment may be uploaded on the Internet.

The information processing device may be configured as a single computer device 600 or may be configured as a system including a plurality of mutually connected computer devices 600.

While certain embodiments have been described, these embodiment have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments as described before may be configured as below.

### CLAUSES

Clause 1. An information processing device, comprising
processing circuitry configured to create, based on information on demand for a medium at one or more demand points and information on production of the medium which is able to be manufactured at a manufacturing point capable of manufacturing the medium, a first schedule for delivering a first container containing the medium among a plurality of points including the manufacturing point and the demand point, wherein
the processing circuitry is configured to create the first schedule based on a constraint that a difference between pressure inside the first container that is delivered to the demand point and pressure inside a second container at the demand point satisfies a condition necessary for transferring the medium from the first container to the second container.

Clause 2. The information processing device according to clause 1, wherein
the condition is that the pressure inside the first container is higher than the pressure inside the second container.

Clause 3. The information processing device according to clause 1 or 2, wherein
the condition is that a value obtained by subtracting a reference amount in accordance with an intended use of the medium at the demand point from a capacity of the first container is equal to or larger than an amount of the medium to be transferred from the first container to the second container.

Clause 4. The information processing device according to clauses 1 to 3, wherein
the first schedule includes
   a schedule for delivering the first container to the demand point from the manufacturing point and
   a schedule for delivering the first container which no longer satisfies the condition from the demand point to another demand point having the second container which satisfies the condition with respect to the first container.

Clause 5. The information processing device according to clause 4, wherein
the first schedule includes a schedule for delivering the first container which no longer satisfies the condition from the demand point to the manufacturing point.

Clause 6. The information processing device according to any one of clauses 1 to 5, wherein
the first schedule is created based on a constraint related to an area of a region in which the first container is installable at the demand point.

Clause 7. The information processing device according to clause 6, wherein
the first container is available in a plurality of container sizes and the area occupied by the first container differs according to the container size.

Clause 8. The information processing device according to any one of clauses 1 to 7, wherein
the processing circuitry is configured to create the first schedule based on an objective function including a term of a first cost in accordance with a total travel distance of delivery of the first container and a term of a second cost of transporting the first container.

Clause 9. The information processing device according to clause 8, wherein
the objective function further includes a term of a third cost in accordance with a number of the first containers used in the first schedule.

Clause 10. The information processing device according to clause 9, wherein
the number of the first containers usable when creating the first schedule is N,
M-number of the first containers are used in the first schedule,
a difference between N and M is the number of the first containers not used in the first schedule, and
the information processing device comprises a data transmitter configured to transmit information on the difference.

Clause 11. The information processing device according to any one of clauses 8 to 10, further comprising
a data transmitter configured to transmit information on the second cost.

Clause 12. The information processing device according to any one of clauses 1 to 11, wherein
the processing circuitry is configured to create, based on the constraint, a second schedule for using a medium in the first container at the demand point together with the first schedule.

Clause 13. The information processing device according to clause 12, wherein
the processing circuitry is configured to create, based on information on a planned period including a plurality of days, the first schedule and the second schedule with respect to the planned period, and
the second schedule includes using, on a first day or on a second day which occurs after the first day, a medium in the first container delivered on the first day according to the first schedule.

Clause 14. The information processing device according to any one of clauses 1 to 13, wherein
the medium is hydrogen.

Clause 15. The information processing device according to any one of clauses 1 to 14, wherein
the processing circuitry is configured to determine, based on position information of a plurality of the manufacturing points and position information of a plurality of the demand points, an area including the demand points to be objects of delivery of the first container for each manufacturing point, and
the processing circuitry is configured to create the first schedule with the demand points in the area as objects for each manufacturing point.

Clause 16. The information processing device according to clause 15, wherein
the processing circuitry is configured to calculate information indicating a variation among the manufacturing points of a sum of distances between each of the manufacturing points and the demand points in the area and to determine the area for each of the manufacturing points based on the calculated information.

Clause 17. An information processing method, comprising
creating, based on information on demand for a medium at one or more demand points and information on production of the medium which is able to be manufactured at a manufacturing point capable of manufacturing the medium, a first schedule for delivering a first container containing the medium among a plurality of points including the manufacturing point and the demand point, wherein
the method includes creating the first schedule based on a constraint that a difference between pressure inside the first container that is delivered to the demand point and pressure inside a second container at the demand point satisfies a condition necessary for transferring the medium from the first container to the second container.

Clause 18. A non-transitory computer readable medium having a computer program stored therein which when executed by a computer, causes the computer to perform processes:
creating, based on information on demand for a medium at one or more demand points and information on production of the medium which is able to be manufactured at a manufacturing point capable of manufacturing the medium, a first schedule for delivering a first container containing the medium among a plurality of points including the manufacturing point and the demand point, wherein
the processes includes creating the first schedule based on a constraint that a difference between pressure inside the first container that is delivered to the demand point and pressure inside a second container at the demand point satisfies a condition necessary for transferring the medium from the first container to the second container.

Clause 19. An information processing system, comprising:
a server configured to transmit data including information on demand for a medium at one or more demand points and information on production of the medium which is able to be manufactured at a manufacturing point capable of manufacturing the medium; and
processing circuitry configured to create, based on the data, a first schedule for delivering a first container containing the medium among a plurality of points including the manufacturing point and the demand point, wherein
the processing circuitry is configured to create the first schedule based on a constraint that a difference between pressure inside the first container that is delivered to the demand point and pressure inside a second container at the demand point satisfies a condition necessary for transferring the medium from the first container to the second container.

Clause 20. The information processing system according to clause 19, further comprising
the second container placed at the demand point.

Clause 21. The information processing system according to clause 19 or 20, wherein
the second container includes an FCV, an FC, an FC scooter, an FC forklift, or a hydrogen jet airplane.

1. An information processing device, comprising
processing circuitry configured to create, based on information on demand for a medium at one or more demand points and information on production of the medium which is able to be manufactured at a manufacturing point capable of manufacturing the medium, a first schedule for delivering a first container containing the medium among a plurality of points including the manufacturing point and the demand point, wherein
the processing circuitry is configured to create the first schedule based on a constraint that a difference between pressure inside the first container that is delivered to the demand point and pressure inside a second container at the demand point satisfies a condition necessary for transferring the medium from the first container to the second container.

2. The information processing device according to claim 1, wherein
the condition is that the pressure inside the first container is higher than the pressure inside the second container.

3. The information processing device according to claim 1, wherein
the condition is that a value obtained by subtracting a reference amount in accordance with an intended use of the medium at the demand point from a capacity of the first container is equal to or larger than an amount of the medium to be transferred from the first container to the second container.

4. The information processing device according to claim 1, wherein
the first schedule includes
a schedule for delivering the first container to the demand point from the manufacturing point and
a schedule for delivering the first container which no longer satisfies the condition from the demand point to another demand point having the second container which satisfies the condition with respect to the first container.

5. The information processing device according to claim 4, wherein
the first schedule includes a schedule for delivering the first container which no longer satisfies the condition from the demand point to the manufacturing point.

6. The information processing device according to claim 1, wherein
the first schedule is created based on a constraint related to an area of a region in which the first container is installable at the demand point.

7. The information processing device according to claim 6, wherein
the first container is available in a plurality of container sizes and the area occupied by the first container differs according to the container size.

8. The information processing device according to claim 1, wherein
the processing circuitry is configured to create the first schedule based on an objective function including a term of a first cost in accordance with a total travel distance of delivery of the first container and a term of a second cost of transporting the first container.

9. The information processing device according to claim 8, wherein
the objective function further includes a term of a third cost in accordance with a number of the first containers used in the first schedule.

10. The information processing device according to claim 9, wherein
the number of the first containers usable when creating the first schedule is N,
M-number of the first containers are used in the first schedule,
a difference between N and M is the number of the first containers not used in the first schedule, and
the information processing device comprises a data transmitter configured to transmit information on the difference.

11. The information processing device according to claim 8, further comprising
a data transmitter configured to transmit information on the second cost.

12. The information processing device according to claim 1, wherein
the processing circuitry is configured to create, based on the constraint, a second schedule for using a medium in the first container at the demand point together with the first schedule.

13. The information processing device according to claim 12, wherein
the processing circuitry is configured to create, based on information on a planned period including a plurality of days, the first schedule and the second schedule with respect to the planned period, and
the second schedule includes using, on a first day or on a second day which occurs after the first day, a medium in the first container delivered on the first day according to the first schedule.

14. The information processing device according to claim 1, wherein
the medium is hydrogen.

15. The information processing device according to claim 1, wherein
the processing circuitry is configured to determine, based on position information of a plurality of the manufacturing points and position information of a plurality of the demand points, an area including the demand points to be objects of delivery of the first container for each manufacturing point, and
the processing circuitry is configured to create the first schedule with the demand points in the area as objects for each manufacturing point.

16. The information processing device according to claim 15, wherein
the processing circuitry is configured to calculate information indicating a variation among the manufacturing points of a sum of distances between each of the manufacturing points and the demand points in the area and to determine the area for each of the manufacturing points based on the calculated information.

17. An information processing method, comprising
creating, based on information on demand for a medium at one or more demand points and information on production of the medium which is able to be manufactured at a manufacturing point capable of manufacturing the medium, a first schedule for delivering a first container containing the medium among a plurality of points including the manufacturing point and the demand point, wherein
the method includes creating the first schedule based on a constraint that a difference between pressure inside the first container that is delivered to the demand point and pressure inside a second container at the demand point satisfies a condition necessary for transferring the medium from the first container to the second container.

18. A non-transitory computer readable medium having a computer program stored therein which when executed by a computer, causes the computer to perform processes:
creating, based on information on demand for a medium at one or more demand points and information on production of the medium which is able to be manufactured at a manufacturing point capable of manufacturing the medium, a first schedule for delivering a first container containing the medium among a plurality of points including the manufacturing point and the demand point, wherein
the processes include creating the first schedule based on a constraint that a difference between pressure inside the first container that is delivered to the demand point and pressure inside a second container at the demand point satisfies a condition necessary for transferring the medium from the first container to the second container.

19. An information processing system, comprising:
a server configured to transmit data including information on demand for a medium at one or more demand points and information on production of the medium which is able to be manufactured at a manufacturing point capable of manufacturing the medium; and
processing circuitry configured to create, based on the data, a first schedule for delivering a first container containing the medium among a plurality of points including the manufacturing point and the demand point, wherein
the processing circuitry is configured to create the first schedule based on a constraint that a difference between pressure inside the first container that is delivered to the demand point and pressure inside a second container at the demand point satisfies a condition necessary for transferring the medium from the first container to the second container.

20. The information processing system according to claim 19, further comprising
the second container placed at the demand point.

21. The information processing system according to claim 19, wherein
the second container includes an FCV, an FC, an FC scooter, an FC forklift, or a hydrogen jet airplane.
